(19) United States
(12) Patent Application Publication
(10) Pub. No.: US 2015/0249839 A1
(43) Pub. Date: Sep. 3, 2015

(54) PICTURE ENCODING METHOD, PICTURE DECODING METHOD, PICTURE ENCODING APPARATUS, PICTURE DECODING APPARATUS, PICTURE ENCODING PROGRAM, PICTURE DECODING PROGRAM, AND RECORDING MEDIA

(71) Applicant: NIPPON TELEGRAPH AND TELEPHONE CORPORATION, Tokyo (JP)

(72) Inventors: Shinya Shimizu, Yokosuka-shi (JP); Shiori Sugimoto, Yokosuka-shi (JP); Hideaki Kimata, Yokosuka-shi (JP); Akira Kojima, Yokosuka-shi (JP)

(73) Assignee: NIPPON TELEGRAPH AND TELEPHONE CORPORATION, Tokyo (JP)

(21) Appl. No.: 14/430,433

(22) PCT Filed: Sep. 24, 2013
(86) PCT No.: PCT/JP2013/075735

§ 371 Date: Mar. 23, 2015

(30) Foreign Application Priority Data
Sep. 25, 2012 (JP) 2012-211154

(51) Int. Cl. H04N 19/597; H04N 19/513

(52) U.S. Cl. CPC H04N 19/597; H04N 19/521

(57) ABSTRACT

A picture encoding method and a picture decoding method are provided which are capable of generating a view-synthesized picture of a processing target frame with small computational complexity without significantly degrading the quality of the view-synthesized picture when the view-synthesized, picture is generated. A picture encoding/decoding method for, when encoding/decoding a multiview picture which includes pictures for a plurality of views, performing the encoding/decoding while predicting a picture between the views using a reference view picture for a view different from a view of a target picture and a reference view depth map which is a depth map of an object within the reference view picture, includes a virtual depth map generating step of generating a virtual depth map which has lower resolution than the target picture and is a depth map of the object within the target picture, and an inter-view picture predicting step of performing inter-view picture prediction by generating a disparity-compensated picture for the target picture from the virtual depth map and the reference view picture.

### TECHNICAL FIELD

The present invention relates to a picture encoding method, a picture decoding method, a picture encoding apparatus, a picture decoding apparatus, a picture encoding program, a picture decoding program, and a recording media for encoding and decoding a multiview picture.

Priority is claimed on Japanese Patent Application No. 2012-211154, filed Sep. 25, 2012, the content of which is incorporated herein by reference.

### BACKGROUND ART

A multiview picture composed of a plurality of pictures obtained by photographing the same object and the same background using a plurality of cameras is conventionally known. This moving picture photographed using the plurality of cameras is referred to as a multiview moving picture (or multiview video). In the following description, a picture (moving picture) captured by one camera is referred to as a “two-dimensional picture (moving picture)”, and a group of two-dimensional pictures (two-dimensional moving pictures) obtained by photographing the same object and the same background using a plurality of cameras differing in a position and/or direction (hereinafter referred to as a view) is referred to as a “multiview picture (multiview moving picture)”.

A two-dimensional moving picture has a strong correlation with respect to a time direction and coding efficiency can be improved by using the correlation. On the other hand, when cameras are synchronized with one another, frames (pictures) corresponding to the same time in videos of the cameras are those obtained by photographing an object and background in completely the same state from different positions, and thus there is a strong correlation between the cameras in a multiview picture and a multiview moving picture. It is possible to improve coding efficiency by using the correlation in coding of a multiview picture and a multiview moving picture.

Here, conventional technology relating to encoding technology of two-dimensional moving pictures will be described. In many conventional two-dimensional moving-picture coding schemes including H.264, MPEG-2, and MPEG-4, which are international coding standards, highly efficient encoding is performed by using technologies of motion-compensated prediction, orthogonal transform, quantization, and entropy encoding. For example, in H.264, encoding using a time correlation with a plurality of past or future frames is possible.

Details of the motion-compensated prediction technology used in H.264, for example, are disclosed in Non-Patent Document 1. An outline of the motion-compensated prediction technology used in H.264 will be described. The motion-compensated prediction of H.264 enables an encoding target frame to be divided into blocks of various sizes and enables each block to have a different motion vector and a different reference frame. Highly precise prediction which compensates for a different motion for a different object is realized by using a different motion vector for each block. On the other hand, high precise prediction considering occlusion caused by a temporal change is realized by using a different reference frame for each block.

Next, a conventional coding scheme for multiview pictures and multiview moving pictures will be described. A difference between a multiview picture encoding method and a multiview moving picture encoding method is that a correlation in the time direction and the correlation between the cameras are simultaneously present in a multiview moving picture. However, the same method using the correlation between the cameras can be used in both cases. Therefore, here, a method to be used in coding multiview moving pictures will be described.

In order to use the correlation between the cameras in the coding of multiview moving pictures, there is a conventional scheme of coding a multiview moving picture with high efficiency through “disparity-compensated prediction” in which motion-compensated prediction is applied to pictures captured by different cameras at the same time. Here, the disparity is a difference between positions at which the same portion on an object is present on picture planes of cameras arranged at different positions. FIG. 13 is a conceptual diagram of the disparity occurring between the cameras. In the conceptual diagram illustrated in FIG. 13, picture planes of cameras having parallel optical axes are looked down vertically. In this manner, the positions at which the same portion on the object is projected on the picture planes of the different cameras are generally referred to as correspondence points.

In the disparity-compensated prediction, each pixel value of the encoding target frame is predicted from a reference frame based on the correspondence relationship, and a predictive residue and disparity information representing the correspondence relationship are encoded. Because the disparity varies depending on a pair of target cameras and their positions, it is necessary to encode disparity information for each region in which the disparity-compensated prediction is performed. Actually, in the multiview coding scheme of H.264, a vector representing the disparity information is encoded for each block in which the disparity-compensated prediction is used.

The correspondence relationship obtained by the disparity information can be represented as a one-dimensional quantity indicating a three-dimensional position of an object, rather than a two-dimensional vector, based on epipolar geometric constraints by using camera parameters. Although there are various representations as information representing a three-dimensional position of an object, the distance from a reference camera to the object or coordinate values on an axis which is not parallel to the picture planes of the cameras is normally used. It is to be noted that the reciprocal of a distance may be used instead of the distance. In addition, because the reciprocal of the distance is information proportional to the disparity, two reference cameras may be set and a three-dimensional position of the object may be represented as a disparity amount between pictures captured by these cameras. Because there is no essential difference in a physical meaning regardless of what expression is used, information representing a three-dimensional position is hereinafter expressed as a depth without distinction of representation.

FIG. 14 is a conceptual diagram of the epipolar geometric constraints. According to the epipolar geometric constraints, a point on a picture of a certain camera corresponding to a point on a picture of another camera is constrained to a straight line called an epipolar line. At this time, when the depth of its pixel is obtained, the correspondence point is uniquely defined on the epipolar line. For example, as illustrated in FIG. 14, a correspondence point in a picture of a second camera picture for an object projected at a position m in a picture of a first camera is projected at a position m′ on the epipolar line when the position of the object in a real space is M′ and it is projected at a position m″ on the epipolar line when the position of the object in the real space is M″.

Non-Patent Document 2 uses this property and generates a highly precise predicted picture by synthesizing a predicted picture for an encoding target frame from a reference frame in accordance with three-dimensional information of each object given by a depth map (distance picture) for the reference frame, thereby realizing efficient multiview moving picture coding. It is to be noted that the predicted picture generated based on the depth is referred to as a view-synthesized picture, a view-interpolated picture, or a disparity-compensated picture.

Furthermore, in Patent Document 1, it is possible to generate a view-synthesized picture only for a necessary region by initially converting a depth map for a reference frame into a depth map for an encoding target frame and obtaining a correspondence point using the converted depth map. Thereby, when a picture or moving picture is encoded or decoded while a method for generating a predicted picture is switched for each region of the encoding target frame or decoding target frame, a reduction in a processing amount for generating the view-synthesized picture and a reduction in a memory amount for temporarily storing the view-synthesized picture are realized.

### PRIOR ART DOCUMENTS

### Patent Document

Patent Document 1: Japanese Unexamined Patent Application, First Publication No. 2010-21844

### Non-Patent Documents

Non-Patent Document 1: ITU-T Recommendation H.264 (March 2009), “Advanced video coding for generic audiovisual services”, March 2009.

Non-Patent Document 2: Shinya SHIMIZU, Masaki KITAHARA, Kazuto KAMIKURA, and Yoshiyuki YASHIMA, “Multiview Video Coding based on 3-D Warping with Depth Map”, In Proceedings of Picture Coding Symposium 2006, SS3-6, April 2006.

### SUMMARY OF INVENTION

### Problems to be Solved by the Invention

With the method disclosed in Patent Document 1, it is possible to obtain a corresponding pixel on a reference frame from a pixel of an encoding target frame because a depth can be obtained for the encoding target frame. Thereby, if a view-synthesized picture is necessary for only a partial region of the encoding target frame, it is possible to reduce the processing amount and the required memory amount by generating the view-synthesized picture for only a designated region of the encoding target frame compared to the case in which the view-synthesized picture of one frame is always generated.

However, because it is necessary to synthesize a depth map for the encoding target frame from a depth map for the reference frame if the view-synthesized picture for the entire encoding target frame is necessary, there is a problem in that the processing amount increases compared to the case in which the view-synthesized picture is directly generated from the depth map for the reference frame.

The present invention has been made in view of such circumstances, and an object thereof is to provide a picture encoding method, a picture decoding method, a picture encoding apparatus, a picture decoding apparatus, a picture encoding program, a picture decoding program, and recording media that are capable of, when generating a view-synthesized picture of a processing target frame, generating the view-synthesized picture through small computational complexity without significantly degrading the quality of a view-synthesized picture.

### Means for Solving the Problems

The present invention is a picture encoding method for, when encoding a multiview picture which includes pictures for a plurality of views, performing the encoding while predicting a picture between the views using an encoded reference view picture for a view different from a view of an encoding target picture and a reference view depth map which is a depth map of an object within the reference view picture, and the method includes: a virtual depth map generating step of generating a virtual depth map which has lower resolution than the encoding target picture and is a depth map of the object within the encoding target picture; and an inter-view picture predicting step of performing inter-view picture prediction by generating a disparity-compensated picture for the encoding target picture from the virtual depth map and the reference view picture.

Preferably, the picture encoding method of the present invention further includes an identical resolution depth map generating step of generating an identical resolution depth map having the same resolution as the encoding target picture from the reference view depth map, and the virtual depth map generating step generates the virtual depth map by reducing the identical resolution depth map.

Preferably, the virtual depth map generating step in the picture encoding method of the present invention generates, for each pixel of the virtual depth map, the virtual depth map by selecting a depth shown to be closest to a view among depths for a plurality of corresponding pixels in the identical resolution depth map.

Preferably, the picture encoding method of the present invention further includes a reduced depth map generating step of generating a reduced depth map of the object within the reference view picture by reducing the reference view depth map, and the virtual depth map generating step generates the virtual depth map from the reduced depth map.

Preferably, the reduced depth map generating step in the picture encoding method of the present invention reduces the reference view depth map only in either a vertical direction or a horizontal direction.

Preferably, the reduced depth map generating step in the picture encoding method of the present invention generates, for each pixel of the reduced depth map, the virtual depth map by selecting a depth shown to be closest to a view among depths for a plurality of corresponding pixels in the reference view depth map.

Preferably, the picture encoding method of the present invention further includes a sample pixel selecting step of selecting a sample pixel from part of pixels of the reference view depth map, and the virtual depth map generating step generates the virtual depth map by performing conversion on the reference view depth map corresponding to the sample pixel.

Preferably, the picture encoding method of the present invention further includes a region dividing step of dividing the reference view depth map into partial regions in accordance with a ratio of resolutions of the reference view depth map and the virtual depth map, and the sample pixel selecting step selects the sample pixel for each partial region.

Preferably, the region dividing step in the picture encoding method of the present invention determines a shape of the partial regions in accordance with the ratio of the resolutions of the reference view depth map and the virtual depth map.

Preferably, the sample pixel selecting step in the picture encoding method of the present invention selects either a pixel having a depth shown to be closest to a view or a pixel having a depth shown to be farthest from the view as the sample pixel for each partial region.

Preferably, the sample pixel selecting step in the picture encoding method of the present invention selects a pixel having a depth shown to be closest to a view and a pixel having a depth shown to be farthest from the view as the sample pixel for each partial region.

The present invention is a picture decoding method for, when decoding a decoding target picture from encoded data of a multiview picture which includes pictures for a plurality of views, performing the decoding while predicting a picture between the views using a decoded reference view picture for a view different from a view of the decoding target picture and a reference view depth map which is a depth map of an object within the reference view picture, and the method includes: a virtual depth map generating step of generating a virtual depth map which has lower resolution than the decoding target picture and is a depth map of the object within the decoding target picture; and an inter-view picture predicting step of performing inter-view picture prediction by generating a disparity-compensated picture for the decoding target picture from the virtual depth map and the reference view picture.

Preferably, the picture decoding method further includes an identical resolution depth map generating step of generating an identical resolution depth map having the same resolution as the decoding target picture from the reference view depth map, and the virtual depth map generating step generates the virtual depth map by reducing the identical resolution depth map.

Preferably, the virtual depth map generating step in the picture decoding method generates, for each pixel of the virtual depth map, the virtual depth map by selecting a depth shown to be closest to a view among depths for a plurality of corresponding pixels in the identical resolution depth map.

Preferably, the picture decoding method further includes a reduced depth map generating step of generating a reduced depth map of the object within the reference view picture by reducing the reference view depth map, and the virtual depth map generating step generates the virtual depth map from the reduced depth map.

Preferably, the reduced depth map generating step in the picture decoding method reduces the reference view depth map only in either a vertical direction or a horizontal direction.

Preferably, the reduced depth map generating step in the picture decoding method generates, for each pixel of the reduced depth map, the virtual depth map by selecting a depth shown to be closest to a view among depths for a plurality of corresponding pixels in the reference view depth map.

Preferably, the picture decoding method further includes a sample pixel selecting step of selecting a sample pixel from part of pixels of the reference view depth map, and the virtual depth map generating step generates the virtual depth map by performing conversion on the reference view depth map corresponding to the sample pixel.

Preferably, the picture decoding method further includes a region dividing step of dividing the reference view depth map into partial regions in accordance with a ratio of resolutions of the reference view depth map and the virtual depth map, and the sample pixel selecting step selects the sample pixel for each partial region.

Preferably, the region dividing step in the picture decoding method determines a shape of the partial regions in accordance with the ratio of the resolutions of the reference view depth map and the virtual depth map.

Preferably, the sample pixel selecting step in the picture decoding method selects either a pixel having a depth shown to be closest to a view or a pixel having a depth shown to be farthest from the view as the sample pixel for each partial region.

Preferably, the sample pixel selecting step in the picture decoding method selects a pixel having a depth shown to be closest to a view and a pixel having a depth shown to be farthest from the view as the sample pixel for each partial region.

The present invention is a picture encoding apparatus for, when encoding a multiview picture which includes pictures for a plurality of views, performing the encoding while predicting a picture between the views using an encoded reference view picture for a view different from a view of an encoding target picture and a reference view depth map which is a depth map of an object within the reference view picture, and the apparatus includes: a virtual depth map generating unit which generates a virtual depth map which has lower resolution than the encoding target picture and is a depth map of the object within the encoding target picture; and an inter-view picture predicting unit which performs inter-view picture prediction by generating a disparity-compensated picture for the encoding target picture from the virtual depth map and the reference view picture.

Preferably, the picture encoding apparatus further includes a reduced depth map generating unit which generates a reduced depth map of the object within the reference view picture by reducing the reference view depth map, and the virtual depth map generating unit generates the virtual depth map by performing conversion on the reduced depth map.

Preferably, the picture encoding apparatus further includes a sample pixel selecting unit which selects a sample pixel from part of pixels of the reference view depth map, and the virtual depth map generating unit generates the virtual depth map by performing conversion on the reference view depth map corresponding to the sample pixel.

The present invention is a picture decoding apparatus for, when decoding a decoding target picture from encoded data of a multiview picture which includes pictures for a plurality of views, performing the decoding while predicting a picture between the views using a decoded reference view picture for a view different from a view of the decoding target picture and a reference view depth map which is a depth map of an object within the reference view picture, and the apparatus includes: a virtual depth map generating unit which generates a virtual depth map which has lower resolution than the decoding target picture and is a depth map of the object within the decoding target picture; and an inter-view picture predicting unit which performs inter-view picture prediction by generating a disparity-compensated picture for the decoding target picture from the virtual depth map and the reference view picture.

Preferably, the picture decoding apparatus further includes a reduced depth map generating unit which generates a reduced depth map of the object within the reference view picture by reducing the reference view depth map, and the virtual depth map generating unit generates the virtual depth map by performing conversion on the reduced depth map.

Preferably, the picture decoding apparatus further includes a sample pixel selecting unit which selects a sample pixel from part of pixels of the reference view depth map, and the virtual depth map generating unit generates the virtual depth map by performing conversion on the reference view depth map corresponding to the sample pixel.

The present invention is a picture encoding program for causing a computer to execute the picture encoding method.

The present invention is a picture decoding program for causing a computer to execute the picture decoding method.

The present invention is a computer-readable recording medium recording the picture encoding program.

The present invention is a computer-readable recording medium recording the picture decoding program.

### Advantageous Effects of the Invention

The present invention provides an advantageous effect in that when a view-synthesized picture of a processing target frame is generated, the view-synthesized picture can be generated through small computational complexity without significantly degrading the quality of the view-synthesized picture.

### BRIEF DESCRIPTION OF DRAWINGS

FIG. 1 is a block diagram illustrating a configuration of a picture encoding apparatus in an embodiment of the present invention.

FIG. 2 is a flowchart illustrating an operation of a picture encoding apparatus 100 illustrated in FIG. 1.

FIG. 3 is a flowchart illustrating an operation of encoding an encoding target picture by alternately iterating a process of generating a view-synthesized picture and a process of encoding an encoding target picture on a block-by-block basis.

FIG. 4 is a flowchart illustrating a processing operation of a process (step S3) of performing conversion on a reference camera depth map illustrated in FIGS. 2 and 3.

FIG. 5 is a flowchart illustrating a processing operation of a process (step S3) of performing conversion on a reference camera depth map illustrated in FIGS. 2 and 3.

FIG. 6 is a flowchart illustrating a processing operation of a process (step S3) of performing conversion on a reference camera depth map illustrated in FIGS. 2 and 3.

FIG. 7 is a flowchart illustrating an operation of generating a virtual depth map from the reference camera depth map.

FIG. 8 is a block diagram illustrating a configuration of a picture decoding apparatus in an embodiment of the present invention.

FIG. 9 is a flowchart illustrating an operation of a picture decoding apparatus 200 illustrated in FIG. 8.

FIG. 10 is a flowchart illustrating an operation of decoding a decoding target picture by alternately iterating a process of generating a view-synthesized picture and a process of decoding a decoding target picture on a block-by-block basis.

FIG. 11 is a diagram illustrating a configuration of hardware when the picture encoding apparatus is configured by a computer and a software program.

FIG. 12 is a diagram illustrating a configuration of hardware when the picture decoding apparatus is configured by a computer and a software program.

FIG. 13 is a conceptual diagram of disparity which occurs between cameras.

FIG. 14 is a conceptual diagram of epipolar geometric constraints.

### MODES FOR CARRYING OUT THE INVENTION

Hereinafter, a picture encoding apparatus and a picture decoding apparatus in accordance with an embodiment of the present invention will be described with reference to the drawings. The following description assumes the case in which a multiview picture captured by two cameras including a first camera (referred to as a camera A) and a second camera (referred to as a camera B) is encoded, and a description will be given on the assumption that a picture of the camera B is encoded or decoded using a picture of the camera A as a reference picture. It is to be noted that information necessary for obtaining a disparity from depth information is assumed to be separately given. Specifically, this information is an external parameter representing a positional relationship between the cameras A and B or an internal parameter representing projection information for picture planes by the cameras, but other information in other forms may be given as long as the disparity is obtained from the depth information. Detailed description relating to these camera parameters, for example, is disclosed in Reference Document 1 <Olivier Faugeras, “Three-Dimensional Computer Vision”, pp. 33 to 66, MIT Press; BCTC/UFF-006.37 F259 1993, ISBN: 0-262-06158-9>. In this document, a description relating to a parameter representing a positional relationship between a plurality of cameras and a parameter representing projection information for a picture plane by a camera are disclosed.

The following description assumes that information (coordinate values or an index capable of being associated with the coordinate values) capable of specifying a position sandwiched by symbols [ ] is added to a picture, a video frame, or a depth map to represent a picture signal sampled by a pixel of the position or a depth corresponding thereto. In addition, it is assumed that the depth is information having a smaller value when the distance from a camera is larger (the disparity is less). When the relationship between the magnitude of the depth and the distance from the camera is inversely defined, it is necessary to appropriately interpret the description with respect to the magnitude of the value for the depth.

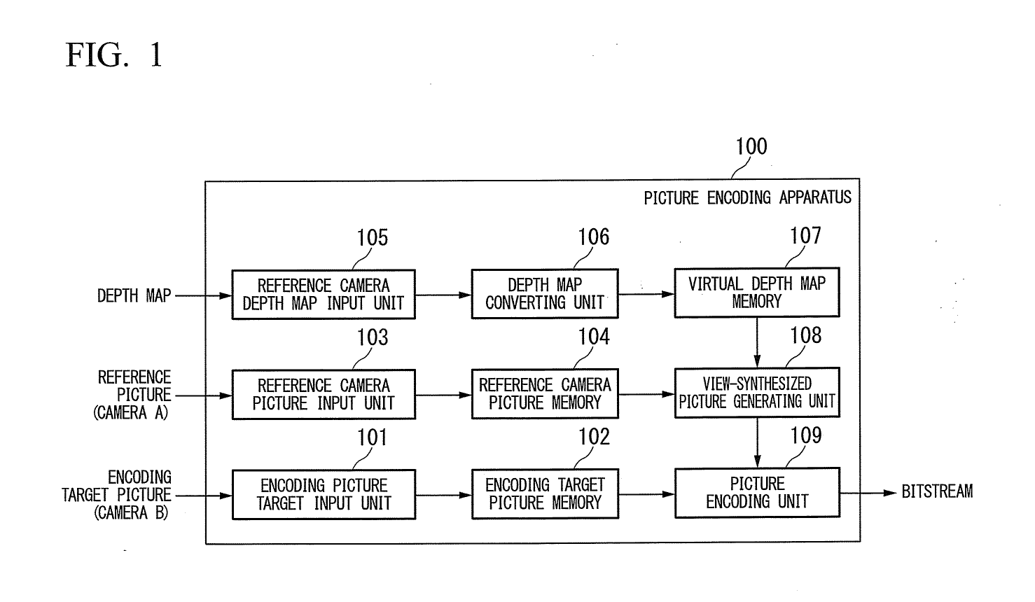

FIG. 1 is a block diagram illustrating a configuration of a picture encoding apparatus in the present embodiment. As illustrated in FIG. 1, the picture encoding apparatus 100 includes an encoding target picture input unit 101, an encoding target picture memory 102, a reference camera picture input unit 103, a reference camera picture memory 104, a reference camera depth map input unit 105, a depth map converting unit 106, a virtual depth map memory 107, a view-synthesized picture generating unit 108, and a picture encoding unit 109.

The encoding target picture input unit 101 inputs a picture serving as an encoding target. Hereinafter, the picture serving as the encoding target is referred to as an encoding target picture. Here, a picture of the camera B is assumed to be input. In addition, a camera (here, the camera B) capturing the encoding target picture is referred to as an encoding target camera. The encoding target picture memory 102 stores the input encoding target picture. The reference camera picture input unit 103 inputs a reference camera picture serving as a reference picture when a view-synthesized picture (disparity-compensated picture) is generated. Here, a picture of the camera A is assumed to be input. The reference camera picture memory 104 stores the input reference camera picture.

The reference camera depth map input unit 105 inputs a depth map for the reference camera picture. Hereinafter, the depth map for the reference camera picture is referred to as a reference camera depth map. It is to be noted that a depth map represents a three-dimensional position of an object shown in each pixel of a corresponding picture. It may be any information as long as the three-dimensional position is obtained from separately given information such as a camera parameter. For example, it is possible to use the distance from a camera to an object, a coordinate value for an axis which is not parallel to a picture plane, and a disparity amount for another camera (e.g., the camera B). In addition, although the depth map is assumed to be given in the form of a picture here, the depth map may not be given in the foam of a picture as long as similar information can be obtained. Hereinafter, a camera corresponding to the reference camera depth map is referred to as a reference camera.

The depth map converting unit 106 generates a depth map of an object photographed in the encoding target picture using the reference camera depth map, wherein the generated depth map has lower resolution than the encoding target picture. That is, the generated depth map can be considered to be a depth map for a picture captured by a camera having low resolution in the same position and direction as the encoding target camera. Hereinafter, the depth map thus generated is referred to as a virtual depth map. The virtual depth map memory 107 stores the generated virtual depth map.

The view-synthesized picture generating unit 108 generates a view-synthesized picture for the encoding target picture using a correspondence relationship between a pixel of the encoding target picture and a pixel of the reference camera picture obtained from the virtual depth map. The picture encoding unit 109 performs predictive encoding on the encoding target picture using the view-synthesized picture and outputs a bitstream which is encoded data.

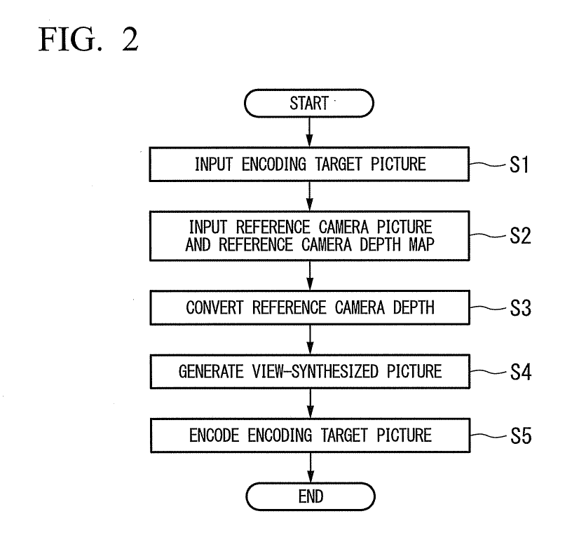

Next, an operation of the picture encoding apparatus 100 illustrated in FIG. 1 will be described with reference to FIG. 2. FIG. 2 is a flowchart illustrating the operation of the picture encoding apparatus 100 illustrated in FIG. 1. First, the encoding target picture input unit 101 inputs an encoding target picture and stores the input encoding target picture in the encoding target picture memory 102 (step S1). Next, the reference camera picture input unit 103 inputs a reference camera picture and stores the input reference camera picture in the reference camera picture memory 104. In parallel therewith, the reference camera depth map input unit 105 inputs a reference camera depth map and outputs the input reference camera depth map to the depth map converting unit 106 (step S2).

It is to be noted that the reference camera picture and the reference camera depth map input in step S2 are assumed to be the same as those to be obtained by a decoding end such as those obtained by performing decoding on an already encoded picture and depth map. This is because the occurrence of coding noise such as a drift can be suppressed by using exactly the same information as that obtained by a decoding apparatus. However, when the occurrence of coding noise is allowed, information obtained in only an encoding end such as information before encoding may be input. With respect to the reference camera depth map, in addition to a depth map obtained by performing decoding on an already encoded depth map, a depth map estimated by applying stereo matching or the like to a multiview picture decoded for a plurality of cameras, a depth map estimated using, for example, a decoded disparity vector or motion vector, or the like can be used as a depth map to be equally obtained in the decoding end.

Next, the depth map converting unit 106 generates a virtual depth map based on the reference camera depth map output from the reference camera depth map input unit 105 and stores the generated virtual depth map in the virtual depth map memory 107 (step S3). It is to be noted that as long as the resolution of the virtual depth map is the same as that of the decoding end, any resolution may be set. For example, the resolution of a predetermined reduction ratio relative to the encoding target picture may be set. Details of this process will be described later.

Next, the view-synthesized picture generating unit 108 generates a view-synthesized picture for the encoding target picture from the reference camera picture stored in the reference camera picture memory 104 and the virtual depth map stored in the virtual depth map memory 107, and outputs the generated view-synthesized picture to the picture encoding unit 109 (step S4). Any method may be used in this process as long as it is a method for synthesizing a picture of the encoding target camera using the depth map for the encoding target camera having lower resolution than the encoding target picture and a picture captured by a different camera from the encoding target camera.

For example, first, one pixel of the virtual depth map is selected, a corresponding region on the encoding target picture is obtained, and a corresponding region on the reference camera picture is obtained from a depth value. Next, a pixel value of the picture in the corresponding region is obtained. Then, the obtained pixel value is allocated as a pixel value of the view-synthesized picture of the identified region on the encoding target picture. A view-synthesized picture of one frame is obtained by performing this process on all pixels of the virtual depth map. It is to be noted that if the correspondence point on the reference camera picture is outside the frame, a pixel value may be absent, a predetermined pixel value may be allocated, or a pixel value of a pixel within the nearest frame or a pixel value of a pixel within the nearest frame on the epipolar straight line may be allocated. However, a method for determining the pixel value needs to be the same as that of the decoding end. Furthermore, after the view-synthesized picture of one frame is obtained, a filter such as a low-pass filter may be applied.

Next, after the view-synthesized picture is obtained, the picture encoding unit 109 performs predictive encoding on the encoding target picture using the view-synthesized picture as a predicted picture and outputs an encoding result (step S5). A bitstream obtained as a result of the encoding becomes an output of the picture encoding apparatus 100. It is to be noted that as long as decoding can be correctly performed in the decoding end, any method may be used in the encoding.

In general moving-picture coding or picture coding such as MPEG-2, H.264, or JPEG, encoding is performed by dividing a picture into blocks each having a predetermined size, generating a difference signal between an encoding target picture and a predicted picture for each block, performing frequency conversion such as a discrete cosine transform (DCT) on a difference picture, and sequentially applying processes of quantization, binarization, and entropy encoding on a resultant value.

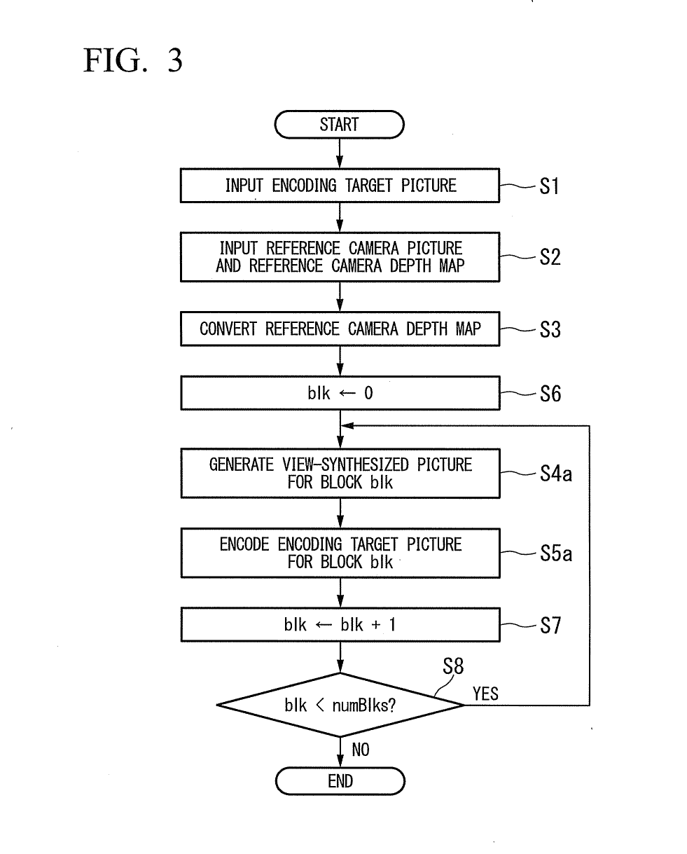

It is to be noted that when the predictive encoding process is performed for each block, the encoding target picture may be encoded by alternately iterating a process of generating a view-synthesized picture (step S4) and a process of encoding an encoding target picture (step S5) on a block-by-block basis. The processing operation of this case will be described with reference to FIG. 3. FIG. 3 is a flowchart illustrating the operation of encoding the encoding target picture by alternately iterating the process of generating the view-synthesized picture and the process of encoding the encoding target picture on the block-by-block basis. In FIG. 3, processing operations that are the same as those illustrated in FIG. 2 are assigned the same reference signs and will be briefly described. In the processing operation illustrated in FIG. 3, an index of a block serving as a unit in which the predictive encoding process is performed is denoted as blk and the number of blocks in the encoding target picture is denoted as numBlks.

First, the encoding target picture input unit 101 inputs an encoding target picture and stores the input encoding target picture in the encoding target picture memory 102 (step S1). Next, the reference camera picture input unit 103 inputs a reference camera picture and stores the input reference camera picture in the reference camera picture memory 104. In parallel therewith, the reference camera depth map input unit 105 inputs a reference camera depth map and outputs the input reference camera depth map to the depth map converting unit 106 (step S2).

Next, the depth map converting unit 106 generates a virtual depth map based on the reference camera depth map output from the reference camera depth map input unit 105 and stores the generated virtual depth map in the virtual depth map memory 107 (step S3). Then, the view-synthesized picture generating unit 108 assigns a value 0 to a variable blk (step S6).

Next, the view-synthesized picture generating unit 108 generates a view-synthesized picture for the block blk from the reference camera picture stored in the reference camera picture memory 104 and the virtual depth map stored in the virtual depth map memory 107 and outputs the generated view-synthesized picture to the picture encoding unit 109 (step S4a). Subsequently, after the view-synthesized picture is obtained, the picture encoding unit 109 performs predictive encoding on the encoding target picture for the block blk using the view-synthesized picture as a predicted picture and outputs an encoding result (step S5a). Then, the view-synthesized picture generating unit 108 increments the variable blk (blk→blk+1, step S7) and determines whether blk<numBlks is satisfied (step S8). If this determination result indicates that blk<numBlks is satisfied, the process is iterated by returning to step S4a and the process ends when blk=numBlks is satisfied.

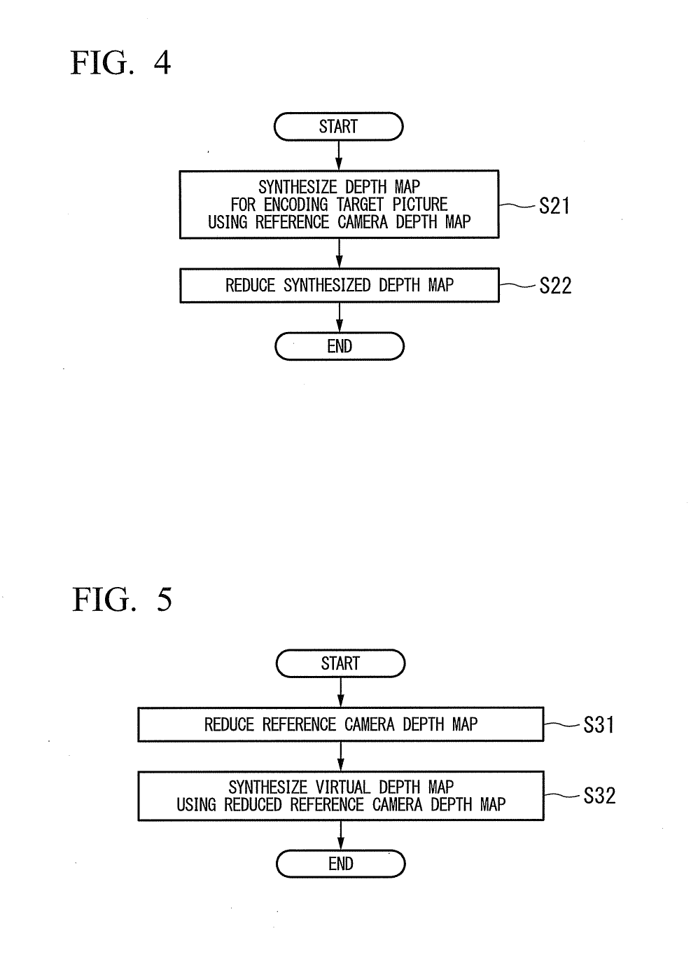

Next, the processing operation of the depth map converting unit 106 illustrated in FIG. 1 will be described with reference to FIGS. 4 to 6. FIGS. 4 to 6 are flowcharts illustrating a processing operation of the process (step S3) of performing conversion on a reference camera depth map illustrated in FIGS. 2 and 3. Here, three different methods will be described as methods for generating a virtual depth map from a reference depth map. Although any method may be used, it is necessary to use the same method as the decoding end. It is to be noted that when a method to be used is changed for each given size such as a frame, information representing the used method may be encoded and the decoding end may be notified of the encoded information.

First, a processing operation in accordance with a first method will be described with reference to FIG. 4. First, the depth map converting unit 106 synthesizes a depth map for an encoding target picture from a reference camera depth map (step S21). That is, the resolution of the depth map obtained here is the same as that of the encoding target picture. Any method may be used in this process as long as the method can be executed on the decoding end, and for example, a method disclosed in Reference Document 2<Y. Mori, N. Fukushima, T. Fujii, and M. Tanimoto, “View Generation with 3D Warping Using Depth Information for FTV”, In Proceedings of 3DTV-CON2008, pp. 229 to 232, May 2008> may be used.

As another method, because a three-dimensional position of each pixel is obtained from the reference camera depth map, a virtual depth map for this region (encoding target picture) may be generated by restoring a three-dimensional model of an object space and obtaining a depth when the restored model is observed from the encoding target camera. As still another method, a virtual depth map may be generated by obtaining a correspondence point on the virtual depth map using a depth value of each pixel of the reference camera depth map and allocating a converted depth value to the correspondence point. Here, the converted depth value is obtained by converting a depth value for the reference camera depth map into a depth value for the virtual depth map. When a common coordinate system is used in the reference camera depth map and the virtual depth map as a coordinate system representing a depth value, the depth value of the reference camera depth map is used without conversion.

It is to be noted that because the correspondence point is not necessarily obtained as an integer pixel position of the virtual depth map, it is necessary to interpolate the depth value for each pixel of the virtual depth map to generate the correspondence point by assuming continuity between positions on the virtual depth map corresponding to adjacent pixels on the reference camera depth map. However, the continuity is assumed only if a change in the depth value for the adjacent pixels on the reference camera depth map is within a predetermined range. This is because different objects are considered to be shown in pixels having significantly different depth values and it is impossible to assume the continuity of the object in the real space. In addition, one or more integer pixel positions may be obtained from the obtained correspondence point and a converted depth value may be allocated to certain pixels at the integer pixel positions. In this case, it is not necessary to interpolate the depth value and thus it is possible to reduce the computational complexity.

In addition, depending on the front-to-back relationship between objects, there is a region on the reference camera picture for which an object that is not shown in the encoding target picture is present because the object shown in a partial region of the reference camera picture is occluded by an object shown in another region of the reference camera picture, and thus it is necessary to allocate a depth value to a correspondence point in consideration of the front-to-back relationship when this method is used. However, when optical axes of the encoding target camera and the reference camera are present on the same plane, it is possible to generate a virtual depth map using a process of always performing overwriting on an obtained correspondence point without taking the front-to-back relationship into consideration by determining the order in which pixels of the reference camera depth map are processed in accordance with a positional relationship between the encoding target camera and the reference camera and processing the pixels of the reference camera depth map in accordance with the determined order. Specifically, it is not necessary to take the front-to-back relationship into consideration by processing the pixels of the reference camera depth map in the scanning order from the left to the right in each row if the encoding target camera is present on the right of the reference camera and by processing the pixels of the reference camera depth map in the scanning order from the right to the left in each row if the encoding target camera is present on the left of the reference camera It is to be noted that because it is not necessary to take the front-to-back relationship into consideration, it is possible to reduce the computational complexity.

Furthermore, when a depth map for a picture captured by a certain camera is synthesized from a depth map for a picture captured by another camera, a valid depth is obtained for only a region commonly shown in the two depth maps. With respect to a region in which no valid depth can be obtained, a depth value estimated by using the method disclosed in Patent Document 1 or the like may be allocated, or no valid value may be set.

Next, when synthesis of the depth map for the encoding target picture is completed, the depth map converting unit 106 generates a virtual depth map of intended resolution by reducing the depth map obtained by the synthesis (step S22). Any method may be used as a method for reducing the depth map as long as the same method is available on the decoding end. For example, there is a method for setting a plurality of corresponding pixels on the depth map obtained by the synthesis for each pixel of the virtual depth map, obtaining an average value, a median value, a mode value, or the like of depth values for these pixels, and setting the obtained value as the depth value of the virtual depth map. It is to be noted that instead of simply calculating the average value, weights may be calculated in accordance with the distance between pixels, and the average value, the median value, or the like may be obtained using the weights. It is to be noted that with respect to the region in which no valid value is set in step S21, the value of its pixel is not taken into consideration in the calculation of the average value or the like.

As another method, there is a method for setting a plurality of corresponding pixels on the depth map obtained by the synthesis for each pixel of the virtual depth map and selecting a depth indicating that its depth value is closest to the camera among depth values for these pixels. Thereby, because prediction efficiency for an object present on the near side which is subjectively more important is improved, it is possible to realize subjectively excellent coding with a small bit amount.

It is to be noted that if no valid depth for a partial region can be obtained in step S21, a depth value estimated by using, for example, the method disclosed in Patent Document 1 may be ultimately allocated to the region in the generated virtual depth map in which no valid depth can be obtained.

Next, a processing operation by a second method will be described with reference to FIG. 5. First, the depth map converting unit 106 reduces the reference camera depth map (step S31). As long as the same process can be executed on the decoding end, the reduction may be performed using any method. For example, the reduction may be performed using a method similar to the above-described step S22. It is to be noted that with respect to the resolution after the reduction, reduction to any resolution may be performed as long as the reduction to the same resolution is possible on the decoding end. For example, conversion of the resolution may be performed in accordance with a predetermined reduction ratio, or the resolution may be the same as that of the virtual depth map. However, the resolution of the depth map after the reduction is set to be equal to or higher than the resolution of the virtual depth map.

In addition, the reduction may be performed in only one of the vertical direction and the horizontal direction. Any method may be used as a method for determining whether the reduction is performed in the vertical direction or the horizontal direction. For example, it may be previously determined or it may be determined in accordance with a positional relationship between the encoding target camera and the reference camera. As a method for determining the direction in accordance with the positional relationship between the encoding target camera and the reference camera, there is a method for setting a direction as different as possible from a direction in which a disparity occurs as the direction in which the reduction is performed. That is, if the encoding target camera and the reference camera are arranged in parallel in the horizontal direction, the reduction is performed in only the vertical direction. With such a determination, a process using a highly precise disparity is possible and it is possible to generate a high-quality virtual depth map in the next step.

Next, when the reduction of the reference camera depth map is completed, the depth map converting unit 106 synthesizes a virtual depth map from the reduced depth map (step S32). The process here is the same as step S21 except that the resolution of the depth map is different. It is to be noted that if the resolution of the depth map obtained by the reduction is different from the resolution of the virtual depth map, when a correspondence pixel on the virtual depth map is obtained for each pixel of the depth map obtained by the reduction, a plurality of pixels of the depth map obtained by the reduction have a correspondence relationship with one pixel of the virtual depth map. At this time, it is possible to generate a higher-quality virtual depth map by allocating a depth value of the pixel having the smallest error in fractional pixel precision. In addition, in order to improve prediction efficiency for an object present on the near side which is subjectively more important, a depth value indicating that the pixel is closest to the camera among a group of the plurality of pixels may be selected.

In this manner, it is possible to reduce the computational complexity necessary to calculate a correspondence point and a three-dimensional model necessary at the time of the synthesis by reducing the number of pixels of the depth map to be used when the virtual depth map is synthesized.

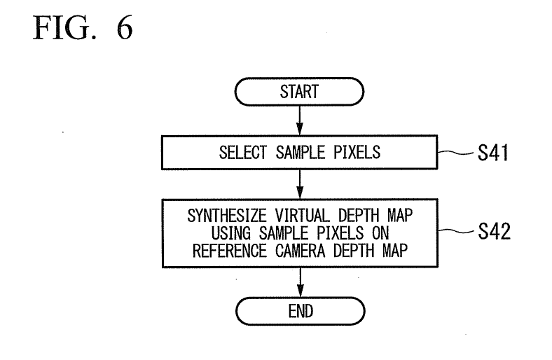

Next, a processing operation in accordance with a third method will be described with reference to FIG. 6. In the third method, first, the depth map converting unit 106 sets a plurality of sample pixels from among pixels of the reference camera depth map (step S41). Any method may be used as the method for selecting the sample pixels as long as it is possible to realize identical selection on the decoding end. For example, the reference camera depth map may be divided into a plurality of regions in accordance with a ratio between the resolution of the reference camera depth map and the resolution of the virtual depth map, and a sample pixel may be selected for each region in accordance with a given rule. The given rule refers to selection of, for example, a pixel present at a specific position within a region, a pixel having a depth indicating that the pixel is farthest from a camera, a pixel having a depth indicating that the pixel is closest to a camera, or the like. It is to be noted that a plurality of pixels may be selected for each region. That is, a plurality of pixels such as four pixels present at four corners within a region, two pixels including a pixel having a depth indicating that the pixel is farthest from a camera and a pixel having a depth indicating that the pixel is closest to a camera, three pixels having depths indicating that the pixels are closer to a camera, or the like may be set as the sample pixels.

It is to be noted that the positional relationship between the encoding target camera and the reference camera may be used in the region-dividing method, in addition to the ratio between the resolution of the reference camera depth map and the resolution of the virtual depth map. For example, there is a method for setting the width of a plurality of pixels in accordance with the ratio between the resolutions in only a direction as different as possible from a direction in which a disparity is generated and setting the width of one pixel in another direction (the direction in which the disparity is generated). In addition, it is possible to reduce the number of pixels in which no valid depth can be obtained and generate a high-quality virtual depth map in the next step by selecting sample pixels having resolution that is greater than or equal to that of the virtual depth map.

Next, when the setting of the sample pixels is completed, the depth map converting unit 106 synthesizes a virtual depth map using only the sample pixels of the reference camera depth map (step S42). The process here is the same as step S32 except that synthesis is performed using part of the pixels.

In this manner, it is possible to reduce the computational complexity necessary to calculate a correspondence point and a three-dimensional model necessary at the time of the synthesis by limiting the number of pixels of the reference camera depth map to be used when the virtual depth map is synthesized. In addition, unlike the second method, it is possible to reduce computations and a temporary memory necessary to reduce the reference camera depth map.

In addition, as another method other than the three methods described above, the virtual depth map may be directly generated from the reference camera depth map. A process of this case is equivalent to the case in which the reduction ratio is set to 1 in the second method and the case in which all pixels of the reference camera depth map are set as the sample pixels in the third method.

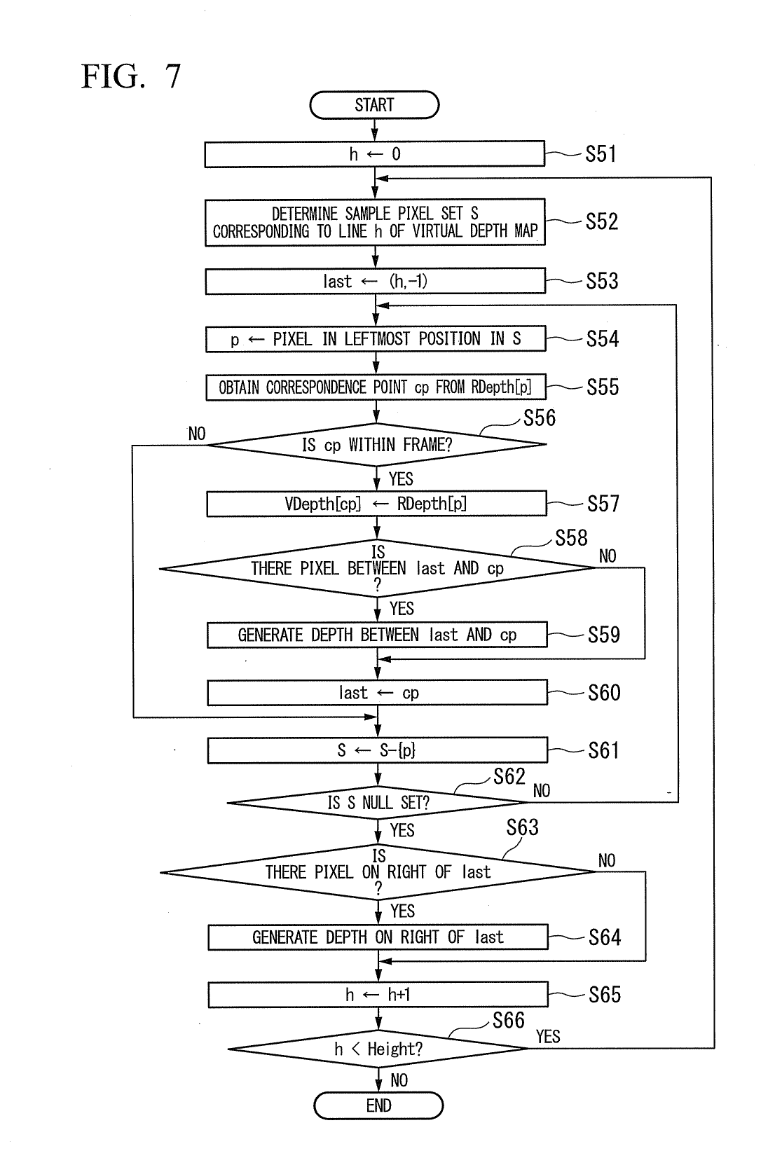

Here, an example of a specific operation of the depth map converting unit 106 when the arrangement of cameras is one-dimensionally parallel will be described with reference to FIG. 7. It is to be noted that the case in which the arrangement of cameras is one-dimensionally parallel is a state in which theoretical projected planes of the cameras are present on the same plane and optical axes are parallel to each other. In addition, here, it is assumed that the cameras are installed to be adjacent in the horizontal direction and the reference camera is present on the left of the encoding target camera. At this time, an epipolar straight line for pixels on a horizontal line on a picture plane becomes a horizontal line present at the same height. Therefore, the disparity is always present in only the horizontal direction. Furthermore, because the projected planes are present on the same plane, axes defining depths agree between the cameras when a depth is represented as a coordinate value for a coordinate axis in the direction of an optical axis.

FIG. 7 is a flowchart illustrating an operation of generating the virtual depth map from the reference camera depth map. In FIG. 7, the reference camera depth map is denoted as RDepth and the virtual depth map is denoted as VDepth. Because the arrangement of the cameras is one-dimensionally parallel, the virtual depth map is generated by converting the reference camera depth map on a line-by-line basis. That is, when an index representing a line of the virtual depth map is denoted as h and the number of lines of the virtual depth map is denoted as Height, the depth map converting unit 106 initializes h to 0 (step S51) and then iterates the following process (steps S52 to S64) while incrementing h by 1 (step S65) until h becomes Height (step S66).

In the process to be performed on a line-by-line basis, first, the depth map converting unit 106 synthesizes a virtual depth map of one line from the reference camera depth map (steps S52 to S62). Thereafter, it is determined whether there is a region in which no depth can be generated from the reference camera depth map on the line (step S63) and depths are generated if there is such a region (step S64). Although any method may be used, for example, a rightmost depth (VDepth[last]) among depths generated on the line may be allocated to all pixels within the region in which no depth can be generated.

In the process of synthesizing the virtual depth map of one line from the reference camera depth map, first, the depth map converting unit 106 determines a sample pixel set S corresponding to a line h of the virtual depth map (step S52). At this time, because the arrangement of the cameras is one-dimensionally parallel, the sample pixel set is selected from among lines N×h to {N×(h+1)−1} of the reference camera depth map when a ratio between the number of lines of the reference camera depth map and the number of lines of the virtual depth map is N:1.

Any method may be used in determining the sample pixel set. For example, a pixel having a depth indicating that the pixel is closest to a camera may be selected as a sample pixel for each column of pixels (a set of pixels in the vertical direction). In addition, one pixel may be selected as a sample pixel for a plurality of columns rather than for one column. The width of the columns at this time may be determined based on a ratio between the number of columns of the reference camera depth map and the number of columns of the virtual depth map. When the sample pixel set is determined, a pixel position “last” on the virtual depth map obtained by warping a sample pixel that has been processed most recently is initialized to (h, −1) (step S53).

Next, when the sample pixel set is determined, the depth map converting unit 106 iterates a process of warping the depth of the reference camera depth map for every pixel included in the sample pixel set. That is, while the processed sample pixel is removed from the sample pixel set (step S61), the following process (steps S54 to S60) is iterated until the sample pixel set becomes a null set (step S62).

In the process which is iterated until the sample pixel set becomes the null set, the depth map converting unit 106 selects a pixel p positioned leftmost on the reference depth map from the sample pixel set as a sample pixel to be processed (step S54). Next, the depth map converting unit 106 obtains a point cp to which the sample pixel p corresponds on the virtual depth map from the value of the reference camera depth map for the sample pixel p (step S55). When the correspondence point cp is obtained, the depth map converting unit 106 checks whether the correspondence point is present within the frame of the virtual depth map (step S56). If the correspondence point is outside the frame, the depth map converting unit 106 ends the process for the sample pixel p without doing anything.

In contrast, if the correspondence point cp is within the frame of the virtual depth map, the depth map converting unit 106 allocates the depth for the pixel p of the reference camera depth map to the pixel of the virtual camera depth map for the correspondence point cp (step S57). Next, the depth map converting unit 106 determines whether there is another pixel between the position “last”, to which the depth of the immediately previous sample pixel is allocated, and the position cp, to which the depth of the current sample pixel is allocated (step S58). If such a pixel is present, the depth map converting unit 106 generates a depth for the pixel between the pixel “last” and the pixel cp (step S59). The depth may be generated using any process. For example, the depths of the pixel “last” and the pixel cp may be linearly interpolated.

Next, when the generation of the depth between the pixel “last” and the pixel cp ends or when no pixel is present between the pixel “last” and the pixel cp, the depth map converting unit 106 updates “last” to cp (step S60) and ends the process for the sample pixel p.

Although the processing operation illustrated in FIG. 7 is a process in which the reference camera is installed on the left of the encoding target camera, it is only necessary to reverse the order of pixels to be processed and a condition for determining the position of a pixel when the positional relationship between the reference camera and the encoding target camera is reversed. Specifically, “last” is initialized to (h, Width) in step S53, a pixel p positioned rightmost on the reference camera depth map among the sample pixel set is selected as a sample pixel to be processed in step S54, it is determined whether there is a pixel on the left of “last” in step S63, and a depth of the left of “last” is generated in step S64. It is to be noted that Width is the number of pixels in the horizontal direction of the virtual depth map.

In addition, although the processing operation illustrated in FIG. 7 is a process when the arrangement of the cameras is one-dimensionally parallel, it is possible to apply the same processing flow even when the arrangement of the cameras is one-dimensional convergence depending on the definition of a depth. Specifically, it is possible to apply the same processing flow if the coordinate axis representing the depth of the reference camera depth map is the same as that of the virtual depth map. In addition, if axes defining depths are different from each other, it is possible to basically apply the same flow simply by performing conversion of a three-dimensional position represented by a depth of the reference camera depth map in accordance with the axes defining the depths and allocating a three-dimensional position obtained by the conversion to the virtual depth map, rather than directly allocating a value of the reference camera depth map to the virtual depth map.

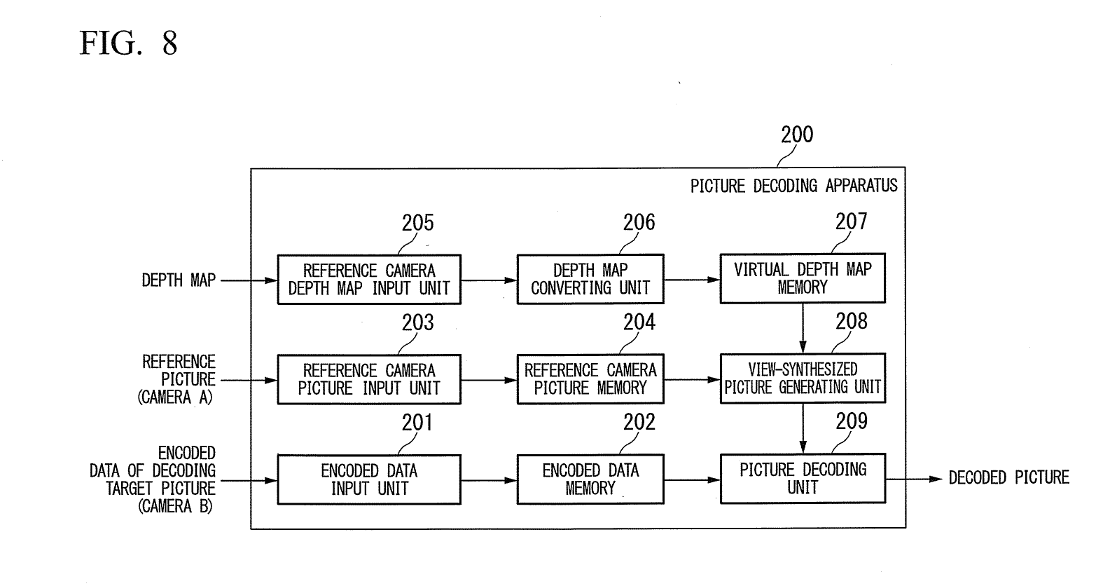

Next, a picture decoding apparatus will be described. FIG. 8 is a block diagram illustrating a configuration of the picture decoding apparatus in the present embodiment. As illustrated in FIG. 8, the picture decoding apparatus 200 includes an encoded data input unit 201, an encoded data memory 202, a reference camera picture input unit 203, a reference camera picture memory 204, a reference camera depth map input unit 205, a depth map converting unit 206, a virtual depth map memory 207, a view-synthesized picture generating unit 208, and a picture decoding unit 209.

The encoded data input unit 201 inputs encoded data of a picture serving as a decoding target. Hereinafter, the picture serving as the decoding target is referred to as a decoding target picture. Here, the decoding target picture refers to a picture of the camera B. In addition, hereinafter, a camera (here, the camera B) capturing the decoding target picture is referred to as a decoding target camera. The encoded data memory 202 stores the input encoded data serving as the decoding target picture. The reference camera picture input unit 203 inputs a reference camera picture serving as a reference picture when a view-synthesized picture (disparity-compensated picture) is generated. Here, a picture of the camera A is input. The reference camera picture memory 204 stores the input reference camera picture.

The reference camera depth map input unit 205 inputs a depth map for the reference camera picture. Hereinafter, the depth map for the reference camera picture is referred to as a reference camera depth map. It is to be noted that the depth map represents a three-dimensional position of an object shown in each pixel of a corresponding picture. It may be any information as long as the three-dimensional position is obtained through separately given information such as a camera parameter. For example, it is possible to use the distance from a camera to an object, a coordinate value for an axis which is not parallel to a picture plane, and a disparity amount for another camera (e.g., the camera B). In addition, although the depth map is assumed to be given in the form of a picture here, the depth map may not be given in the form of a picture as long as similar information can be obtained. Hereinafter, a camera corresponding to the reference camera depth map is referred to as a reference camera.

The depth map converting unit 206 generates a depth map of an object photographed in the decoding target picture using the reference camera depth map, wherein the generated depth map has lower resolution than the decoding target picture. That is, the generated depth map can be considered to be a depth map for a picture captured by the camera having low resolution in the same position and direction as the decoding target camera. Hereinafter, the depth map thus generated is referred to as a virtual depth map. The virtual depth map memory 207 stores the generated virtual depth map. The view-synthesized picture generating unit 208 generates a view-synthesized picture for the decoding target picture using a correspondence relationship between a pixel of the decoding target picture and a pixel of the reference camera picture obtained from the virtual depth map. The picture decoding unit 209 decodes the decoding target picture from the encoded data using the view-synthesized picture and outputs the decoded picture.

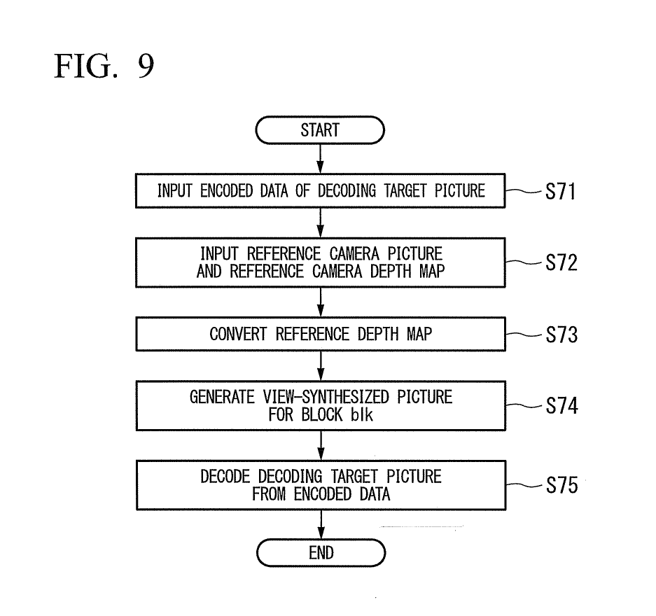

Next, an operation of the picture decoding apparatus 200 illustrated in FIG. 8 will be described with reference to FIG. 9. FIG. 9 is a flowchart illustrating the operation of the picture decoding apparatus 200 illustrated in FIG. 8. First, the encoded data input unit 201 inputs encoded data of a decoding target picture and stores the input encoded data in the encoded data memory 202 (step S71). In parallel therewith, the reference camera picture input unit 203 inputs a reference camera picture and stores the input reference camera picture in the reference camera picture memory 204. In addition, the reference camera depth map input unit 205 inputs a reference camera depth map and outputs the input reference camera depth map to the depth map converting unit 206 (step S72).

It is to be noted that the reference camera picture and the reference camera depth map input in step S72 are assumed to be the same as those used by the encoding end. This is because the occurrence of coding noise such as a drift is suppressed by using exactly the same information as that used by the encoding apparatus. However, when the occurrence of coding noise is allowed, information different from that used in encoding may be input. With respect to the reference camera depth map, a depth map estimated by applying stereo matching or the like to a multiview picture decoded for a plurality of cameras, a depth map estimated using, for example, a decoded disparity vector or motion vector, or the like can be used in addition to a separately decoded depth map.

Next, the depth map converting unit 206 generates a virtual depth map from the reference camera depth map and stores the generated virtual depth map in the virtual depth map memory 207 (step S73). The process here is the same as step S3 illustrated in FIG. 2 except for differences in terms of encoding and decoding such as an encoding target picture and a decoding target picture.

Next, when the virtual depth map is obtained, the view-synthesized picture generating unit 208 generates a view-synthesized picture for the decoding target picture from the reference camera picture and the virtual depth map and outputs the generated view-synthesized picture to the picture decoding unit 209 (step S74). The process here is the same as step S4 illustrated in FIG. 2 except for differences in terms of encoding and decoding such as an encoding target picture and a decoding target picture.

Next, after the view-synthesized picture is obtained, the picture decoding unit 209 decodes the decoding target picture from the encoded data while using the view-synthesized picture as a predicted picture (step S75). The decoded picture obtained as a result of the decoding becomes an output of the picture decoding apparatus 200. It is to be noted that as long as decoding on encoded data (a bitstream) can be correctly performed, any method may be used in the decoding. In general, a method corresponding to that used at the time of encoding is used.

When encoding is performed by general moving-picture coding or picture coding such as MPEG-2, H.264, or PEG the decoding is performed by dividing a picture into blocks each having a predetermined size, for each block, performing entropy decoding, inverse binarization, inverse quantization, and the like, followed by performing inverse frequency conversion such as an inverse discrete cosine transform (IDCT) to thereby obtain a predictive residual signal, adding a predicted picture to the predictive residual signal, and clipping an obtained result in a range of a pixel value.

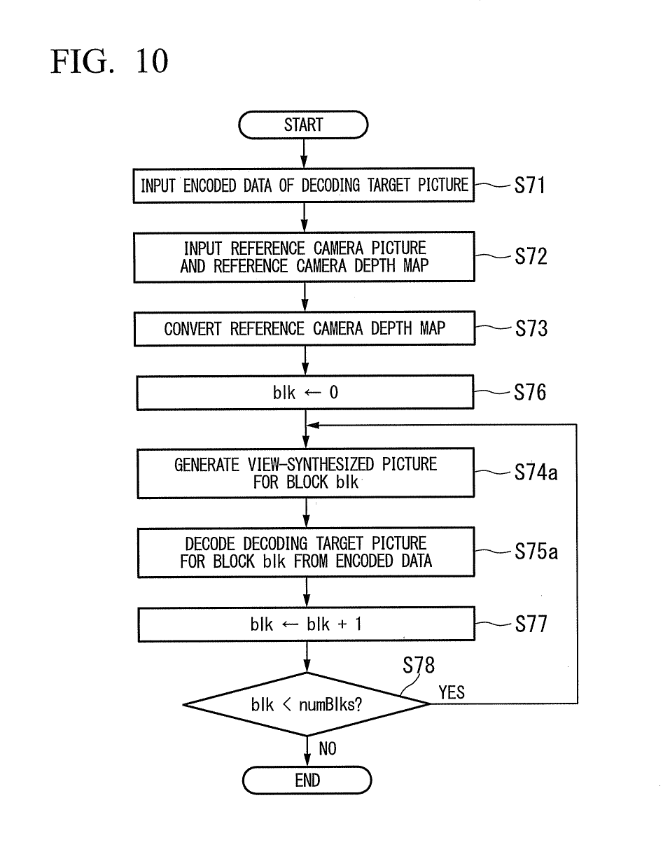

It is to be noted that when the decoding process is performed on a block-by-block basis, the decoding target picture may be decoded by alternately iterating the process of generating the view-synthesized picture (step S74) and the process of decoding the decoding target picture (step S75) on a block-by-block basis. The processing operation of this case will be described with reference to FIG. 10. FIG. 10 is a flowchart illustrating an operation of decoding the decoding target picture by alternately iterating the process of generating the view-synthesized picture and the process of decoding the decoding target picture on a block-by-block basis. In FIG. 10, processing operations that are the same as those illustrated in FIG. 9 are assigned the same reference signs and will be briefly described. In the processing operation illustrated in FIG. 10, an index of a block serving as a unit in which the decoding process is performed is denoted as blk and the number of blocks in the decoding target picture is denoted as numBlks.

First, the encoded data input unit 201 inputs encoded data of a decoding target picture and stores the input encoded data in the encoded data memory 202 (step S71). In parallel therewith, the reference camera picture input unit 203 inputs a reference camera picture and stores the input reference camera picture in the reference camera picture memory 204. In addition, the reference camera depth map input unit 205 inputs a reference camera depth map and outputs the input reference camera depth map to the depth map converting unit 206 (step S72).

Next, the depth map converting unit 206 generates a virtual depth map from the reference camera depth map and stores the generated virtual depth map in the virtual depth map memory 207 (step S73). Then, the view-synthesized picture generating unit 208 assigns a value 0 to a variable blk (step S76).

Next, the view-synthesized picture generating unit 208 generates a view-synthesized picture for the block blk from the reference camera picture and the virtual depth map and outputs the generated view-synthesized picture to the picture decoding unit 209 (step S74a). Subsequently, the picture decoding unit 209 decodes a decoding target picture for the block blk from the encoded data while using the view-synthesized picture as a predicted picture and outputs a decoded result (step S75a). Then, the view-synthesized picture generating unit 208 increments the variable blk (blk→blk+1, step S77), and determines whether blk<numBlks is satisfied (step S78). If a determination result indicates that blk<numBlks is satisfied, the process is iterated by returning to step S74a and the process ends when blk=numBlks is satisfied.

In this manner, it is possible to realize the generation of the view-synthesized picture for only a designated region with small computational complexity and consumed memory and realize efficient and lightweight picture coding of a multiview picture by generating a depth map of low resolution for a processing target frame from a depth map for a reference frame. Thereby, when the view-synthesized picture of the processing target frame (encoding target frame or decoding target frame) is generated using the depth map for the reference frame, it is possible to generate the view-synthesized picture on a block-by-block basis with small computational complexity without significantly degrading quality of the view-synthesized picture.

Although a process of encoding and decoding all pixels of one frame has been described in the above description, a process of the embodiment of the present invention may be applied to only some pixels and encoding or decoding for the other pixels may be performed using, for example, intra-frame predictive coding or motion-compensated predictive coding to be used in H.264/AVC or the like. In this case, it is necessary to encode and decode information representing a method used for prediction for each pixel.

In addition, encoding or decoding may be performed using a different prediction scheme for each block rather than each pixel. It is to be noted that when prediction using a view-synthesized picture is performed only on some pixels or blocks, it is possible to reduce the computational complexity related to a process (steps S4, S4a, S74, and S74a) of generating the view-synthesized picture by performing the process of generating the view-synthesized picture only for the pixels.

In addition, although a process of encoding and decoding one frame has been described in the above description, it is also possible to apply the embodiment of the present invention to moving-picture coding by iterating the process for a plurality of frames. In addition, it is possible to apply the embodiment of the present invention to only some frames or blocks of a moving picture. Furthermore, although the configurations and the processing operations of the picture encoding apparatus and the picture decoding apparatus have been mainly described in the above description, it is possible to realize a picture encoding method and a picture decoding method of the present invention in accordance with processing operations corresponding to the operations of the units of the picture encoding apparatus and the picture decoding apparatus.

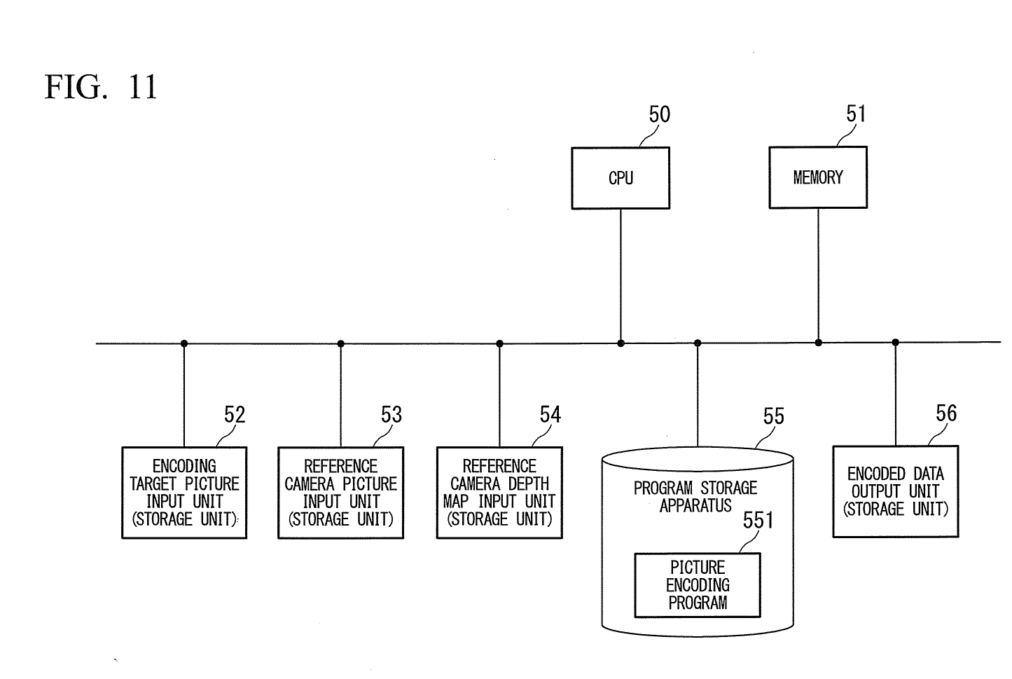

FIG. 11 is block diagram illustrating a configuration of hardware when the above-described picture encoding apparatus is configured by a computer and a software program. The system illustrated in FIG. 11 is configured such that a central processing unit (CPU) 50 which executes the program, a memory 51 such as a random access memory (RAM) storing the program and data to be accessed by the CPU 50, an encoding target picture input unit 52 (which may be a storage unit which stores a picture signal by a disk apparatus or the like) which inputs a picture signal of an encoding target from a camera or the like, a reference camera picture input unit 53 (which may be a storage unit which stores a picture signal by a disk apparatus or the like) which inputs a picture signal of a reference target from a camera or the like, a reference camera depth map input unit 54 (which may be a storage unit which stores a depth map by a disk apparatus or the like) which inputs a depth map for a camera of a different position and direction from the camera capturing the encoding target picture from a depth camera or the like, a program storage apparatus 55 which stores a picture encoding program 551 which is a software program for causing the CPU 50 to execute the above-described picture encoding process, and an encoded data output unit 56 (which may be a storage unit which stores encoded data by a disk apparatus or the like) which outputs encoded data generated by executing the picture encoding program 551 loaded by the CPU 50 to the memory 51, for example, via a network, are connected by a bus.

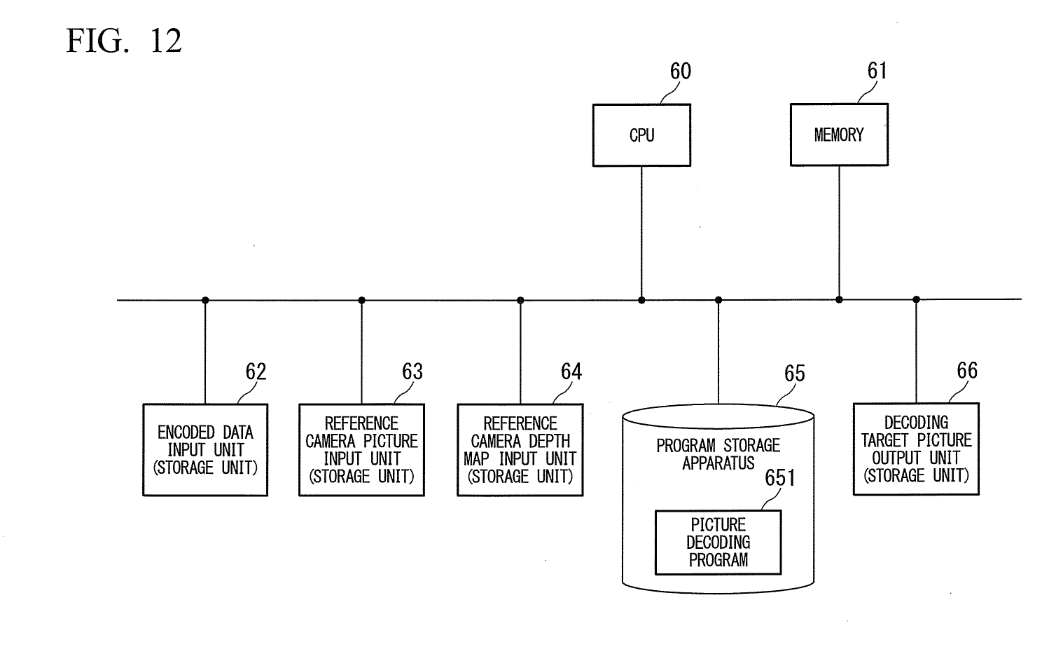

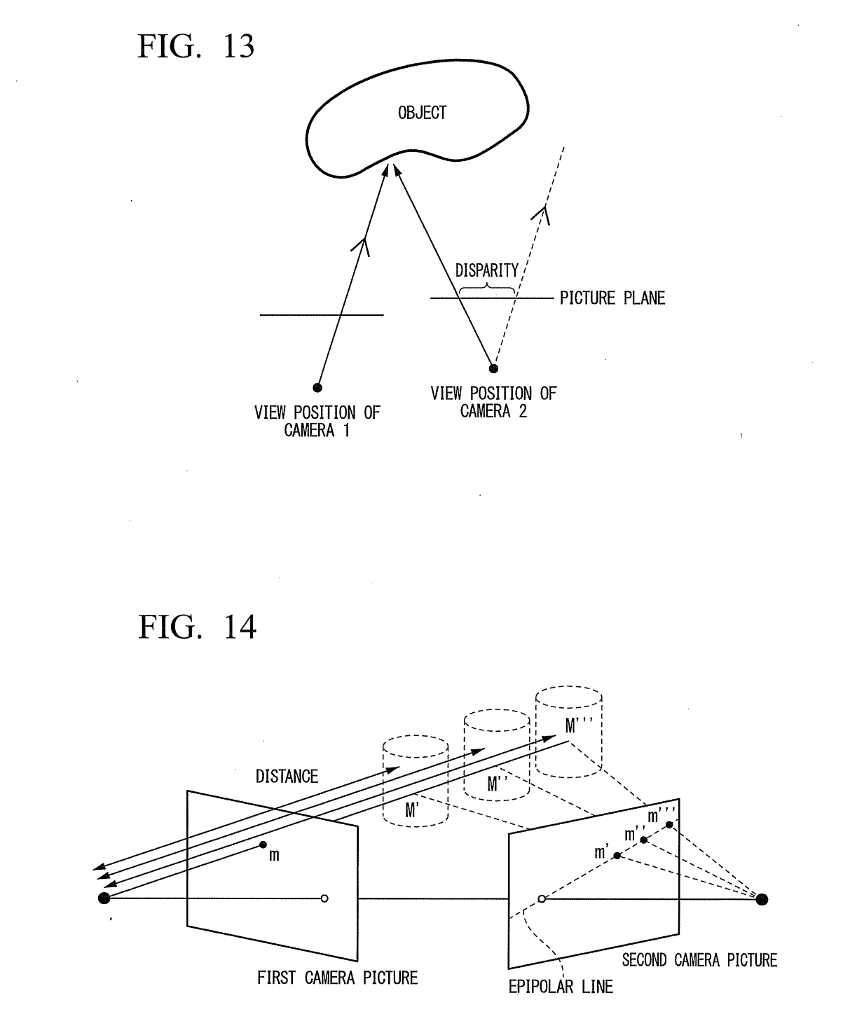

FIG. 12 is a block diagram illustrating a configuration of hardware when the above-described picture decoding apparatus is configured by a computer and a software program. The system illustrated in FIG. 12 is configured such that a CPU 60 which executes the program, a memory 61 such as a RAM storing the program and data to be accessed by the CPU 60, an encoded data input unit 62 (which may be a storage unit which stores encoded data by a disk apparatus or the like) which inputs encoded data encoded by the picture encoding apparatus in accordance with the present technique, a reference camera picture input unit 63 (which may be a storage unit which stores a picture signal by a disk apparatus or the like) which inputs a picture signal of a reference target from a camera or the like, a reference camera depth map input unit 64 (which may be a storage unit which stores depth information by a disk apparatus or the like) which inputs a depth map for a camera of a different position and direction from a camera capturing a decoding target from a depth camera or the like, a program storage apparatus 65 which stores a picture decoding program 651 which is a software program for causing the CPU 60 to execute the above-described picture decoding process, and a decoding target picture output unit 66 (which may be a storage unit which stores a picture signal by a disk apparatus or the like) which outputs a decoding target picture obtained by performing decoding on the encoded data to a reproduction apparatus or the like by executing the picture decoding program 651 loaded by the CPU 60 to the memory 61 are connected by a bus.

In addition, the picture encoding process and the picture decoding process may be executed by recording a program for realizing functions of the processing units in the picture encoding apparatus illustrated in FIG. 1 and the picture decoding apparatus illustrated in FIG. 8 on a computer-readable recording medium and causing a computer system to read and execute the program recorded on the recording medium. It is to be noted that the “computer system” referred to here may include an operating system (OS) and hardware such as peripheral devices. In addition, the computer system may include a World Wide Web (WWW) system which is provided with a homepage providing environment (or displaying environment). In addition, the “computer-readable recording medium” refers to a portable medium such as a flexible disk, a magneto-optical disc, a read only memory (ROM), or a compact disc (CD)-ROM, and a storage apparatus such as a hard disk embedded in the computer system. Furthermore, the “computer-readable recording medium” is assumed to be a medium that holds a program for a constant period of time, such as a volatile memory (e.g., RAM) inside a computer system serving as a server or a client when the program is transmitted via a network such as the Internet or a communication circuit such as a telephone circuit.

In addition, the above program may be transmitted from a computer system storing the program in a storage apparatus or the like via a transmission medium or transmission waves in the transmission medium to another computer system. Here, the “transmission medium” for transmitting the program refers to a medium having a function of transmitting information, such as a network (communication network) like the Internet or a communication circuit (communication line) like a telephone circuit. In addition, the above program may be a program for realizing part of the above-described functions. Furthermore, the above-described program may be a program, i.e., a so-called differential file (differential program), capable of realizing the above-described functions in combination with a program already recorded on the computer system.

While the embodiment of the present invention has been described above with reference to the drawings, it is apparent that the above embodiment is exemplary of the present invention and the present invention is not limited to the above embodiment. Accordingly, additions, omissions, substitutions, and other modifications of constituent elements may be made without departing from the technical idea and scope of the present invention.

### INDUSTRIAL APPLICABILITY

The present invention is applicable for essential use in achieving high coding efficiency with small computational complexity when disparity-compensated prediction is performed on an encoding (decoding) target picture using a depth map representing a three-dimensional position of an object for a reference frame.

### DESCRIPTION OF REFERENCE SIGNS

100 Picture encoding apparatus
101 Encoding target picture input unit
102 Encoding target picture memory
103 Reference camera picture input unit
104 Reference camera picture memory
105 Reference camera depth map input unit
106 Depth map converting unit
107 Virtual depth map memory
108 View-synthesized picture generating unit
109 Picture encoding unit
200 Picture decoding apparatus
201 Encoded data input unit
202 Encoded data memory
203 Reference camera picture input unit
204 Reference camera picture memory
205 Reference camera depth map input unit
206 Depth map converting unit
207 Virtual depth map memory
208 View-synthesized picture generating unit
209 Picture decoding unit

1-3. (canceled)

4. A picture encoding method for, when encoding a multiview picture which includes pictures for a plurality of views, performing the encoding while predicting a picture between the views using an encoded reference view picture for a view different from a view of an encoding target picture and a reference view depth map which is a depth map of an object within the reference view picture, the method comprising:
a reduced depth map generating step of generating a reduced depth map of the object within the reference view picture by reducing the reference view depth map;
a virtual depth map generating step of generating a virtual depth map which has lower resolution than the encoding target picture and is a depth map of the object within the encoding target picture from the reduced depth map; and
an inter-view picture predicting step of performing inter-view picture prediction by generating a disparity-compensated picture for the encoding target picture from the virtual depth map and the reference view picture.

5. The picture encoding method according to claim 4, wherein the reduced depth map generating step reduces the reference view depth map only in either a vertical direction or a horizontal direction.

6. The picture encoding method according to claim 4 or 5, wherein the reduced depth map generating step generates, for each pixel of the reduced depth map, the virtual depth map by selecting a depth shown to be closest to a view among depths for a plurality of corresponding pixels in the reference view depth map.

7. A picture encoding method for, when encoding a multiview picture which includes pictures for a plurality of views, performing the encoding while predicting a picture between the views using an encoded reference view picture for a view different from a view of an encoding target picture and a reference view depth map which is a depth map of an object within the reference view picture, the method comprising:
a sample pixel selecting step of selecting a sample pixel from part of pixels of the reference view depth map;
a virtual depth map generating step of generating a virtual depth map which has lower resolution than the encoding target picture and is a depth map of the object within the encoding target picture by performing conversion on the reference view depth map corresponding to the sample pixel; and
an inter-view picture predicting step of performing inter-view picture prediction by generating a disparity-compensated picture for the encoding target picture from the virtual depth map and the reference view picture.

8. The picture encoding method according to claim 7, further comprising a region dividing step of dividing the reference view depth map into partial regions in accordance with a ratio of resolutions of the reference view depth map and the virtual depth map,
wherein the sample pixel selecting step selects the sample pixel for each partial region.

9. The picture encoding method according to claim 8, wherein the region dividing step determines a shape of the partial regions in accordance with the ratio of the resolutions of the reference view depth map and the virtual depth map.

10. The picture encoding method according to claim 8 or 9, wherein the sample pixel selecting step selects either a pixel having a depth shown to be closest to a view or a pixel having a depth shown to be farthest from the view as the sample pixel for each partial region.

11. The picture encoding method according to claim 8 or 9, wherein the sample pixel selecting step selects a pixel having a depth shown to be closest to a view and a pixel having a depth shown to be farthest from the view as the sample pixel for each partial region.

12-14. (canceled)

15. A picture decoding method for, when decoding a decoding target picture from encoded data of a multiview picture which includes pictures for a plurality of views, performing the decoding while predicting a picture between the views using a decoded reference view picture for a view different from a view of the decoding target picture and a reference view depth map which is a depth map of an object within the reference view picture, the method comprising:
a reduced depth map generating step of generating a reduced depth map of the object within the reference view picture by reducing the reference view depth map;
a virtual depth map generating step of generating a virtual depth map which has lower resolution than the decoding target picture and is a depth map of the object within the decoding target picture from the reduced depth map; and
an inter-view picture predicting step of performing inter-view picture prediction by generating a disparity-compensated picture for the decoding target picture from the virtual depth map and the reference view picture.

16. The picture decoding method according to claim 15, wherein the reduced depth map generating step reduces the reference view depth map only in either a vertical direction or a horizontal direction.

17. The picture decoding method according to claim 15 or 16, wherein the reduced depth map generating step generates, for each pixel of the reduced depth map, the virtual depth map by selecting a depth shown to be closest to a view among depths for a plurality of corresponding pixels in the reference view depth map.

18. A picture decoding method for, when decoding a decoding target picture from encoded data of a multiview picture which includes pictures for a plurality of views, performing the decoding while predicting a picture between the views using a decoded reference view picture for a view different from a view of the decoding target picture and a reference view depth map which is a depth map of an object within the reference view picture, the method comprising:
a sample pixel selecting step of selecting a sample pixel from part of pixels of the reference view depth map;
a virtual depth map generating step of generating a virtual depth map which has lower resolution than the decoding target picture and is a depth map of the object within the decoding target picture by performing conversion on the reference view depth map corresponding to the sample pixel; and
an inter-view picture predicting step of performing inter-view picture prediction by generating a disparity-compensated picture for the decoding target picture from the virtual depth map and the reference view picture.

19. The picture decoding method according to claim 18, further comprising a region dividing step of dividing the reference view depth map into partial regions in accordance with a ratio of resolutions of the reference view depth map and the virtual depth map,
wherein the sample pixel selecting step selects the sample pixel for each partial region.

20. The picture decoding method according to claim 19, wherein the region dividing step determines a shape of the partial regions in accordance with the ratio of the resolutions of the reference view depth map and the virtual depth map.

21. The picture decoding method according to claim 19 or 20, wherein the sample pixel selecting step selects either a pixel having a depth shown to be closest to a view or a pixel having a depth shown to be farthest from the view as the sample pixel for each partial region.

22. The picture decoding method according to claim 19 or 20, wherein the sample pixel selecting step selects a pixel having a depth shown to be closest to a view and a pixel having a depth shown to be farthest from the view as the sample pixel for each partial region.

23. (canceled)

24. A picture encoding apparatus for, when encoding a multiview picture which includes pictures for a plurality of views, performing the encoding while predicting a picture between the views using an encoded reference view picture for a view different from a view of an encoding target picture and a reference view depth map which is a depth map of an object within the reference view picture, the apparatus comprising:
a reduced depth map generating unit which generates a reduced depth map of the object within the reference view picture by reducing the reference view depth map;
a virtual depth map generating unit which generates a virtual depth map which has lower resolution than the encoding target picture and is a depth map of the object within the encoding target picture by performing conversion on the reduced depth map; and
an inter-view picture predicting unit which performs inter-view picture prediction by generating a disparity-compensated picture for the encoding target picture from the virtual depth map and the reference view picture.

25. A picture encoding apparatus for, when encoding a multiview picture which includes pictures for a plurality of views, performing the encoding while predicting a picture between the views using an encoded reference view picture for a view different from a view of an encoding target picture and a reference view depth map which is a depth map of an object within the reference view picture, the apparatus comprising:
a sample pixel selecting unit which selects a sample pixel from part of pixels of the reference view depth map;
a virtual depth map generating unit which generates a virtual depth map which has lower resolution than the encoding target picture and is a depth map of the object within the encoding target picture by performing conversion on the reference view depth map corresponding to the sample pixel; and
an inter-view picture predicting unit which performs inter-view picture prediction by generating a disparity-compensated picture for the encoding target picture from the virtual depth map and the reference view picture.

26. (canceled)

27. A picture decoding apparatus for, when decoding a decoding target picture from encoded data of a multiview picture which includes pictures for a plurality of views, performing the decoding while predicting a picture between the views using a decoded reference view picture for a view different from a view of the decoding target picture and a reference view depth map which is a depth map of an object within the reference view picture, the apparatus comprising:
a reduced depth map generating unit which generates a reduced depth map of the object within the reference view picture by reducing the reference view depth map;
a virtual depth map generating unit which generates a virtual depth map which has lower resolution than the decoding target picture and is a depth map of the object within the decoding target picture by performing conversion on the reduced depth map; and
an inter-view picture predicting unit which performs inter-view picture prediction by generating a disparity-compensated picture for the decoding target picture from the virtual depth map and the reference view picture.

28. A picture decoding apparatus for, when decoding a decoding target picture from encoded data of a multiview picture which includes pictures for a plurality of views, performing the decoding while predicting a picture between the views using a decoded reference view picture for a view different from a view of the decoding target picture and a reference view depth map which is a depth map of an object within the reference view picture, the apparatus comprising:
a sample pixel selecting unit which selects a sample pixel from part of pixels of the reference view depth map;
a virtual depth map generating unit which generates a virtual depth map which has lower resolution than the decoding target picture and is a depth map of the object within the decoding target picture by performing conversion on the reference view depth map corresponding to the sample pixel; and
an inter-view picture predicting unit which performs inter-view picture prediction by generating a disparity-compensated picture for the decoding target picture from the virtual depth map and the reference view picture.

29. A picture encoding program for causing a computer to execute the picture encoding method according to any one of claims 4, 5, 7, 8, and 9.

30. A picture decoding program for causing a computer to execute the picture decoding method according to any one of claims 15, 16, 18, 19, and 20.

31. A computer-readable recording medium recording the picture encoding program according to claim 29.

32. A computer-readable recording medium recording the picture decoding program according to claim 30.
